(19) United States
(12) Patent Application Publication
(10) Pub. No.: US 2008/0182026 A1
(43) Pub. Date: Jul. 31, 2008

(54) REACTIVE ELEMENT-MODIFIED ALUMINIDE COATING FOR GAS TURBINE AIRFOILS

(75) Inventors: Yiping Hu, Greer, SC (US); Derek Raybould, Denville, NJ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/749,943

(22) Filed: May 17, 2007

Related U.S. Application Data
(60) Provisional application No. 60/898,498, filed on Jan. 31, 2007.

(51) Int. Cl. B05D 3/04

(52) U.S. Cl. 427/343

(57) ABSTRACT

A method for producing environment-protective coatings on a gas turbine engine component includes forming a substrate having an outer surface. The substrate includes a nickel-based superalloy that contains at least one reactive element. A first coating comprising aluminum is then formed on the substrate outer surface. The at least one reactive element is then diffused into the first coating to produce a reactive element-modified aluminide coating.

### CROSS-REFERENCE TO RELATED APPLICATION

This application claims the benefit of U.S. Provisional Application No. 60/898,498 filed Jan. 31, 2007.

### FIELD OF THE INVENTION

The present invention generally relates to gas turbine airfoils and to airfoil coatings that provide environmental protection. More particularly, the present invention relates to barrier coatings that increase the airfoils' operating temperature limits and service lives.

### BACKGROUND OF THE INVENTION

Turbine engines are used as the primary power source for various aircraft applications. Most turbine engines generally follow the same basic power generation process. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disc. The force of the impinging gas causes the turbine disc to spin at high speed. Jet propulsion engines use the power created by the rotating turbine disc to draw more ambient air into the engine and the high velocity combustion gas is passed out of the gas turbine aft end to create forward thrust. Other engines use this power to turn one or more propellers, electrical generators, or other devices.

Since turbine engines provide power for many primary and secondary functions, it is important to optimize both the engine service life and the operating efficiency. Although hotter combustion gases typically produce more efficient engine operation, the high temperatures create an environment that promotes oxidation and corrosion. For this reason, diverse coatings and coating methods have been developed to increase the operating temperature limits and service lives of the high pressure turbine components, including the turbine blades and vane airfoils.

Some conventional environmental protection coatings and bond coats that are applied onto the airfoil surfaces, as well as onto other turbine components, to provide protection against oxidation and corrosion attack include platinum-modified nickel aluminides, active element-modified aluminides, and MCrAlY overlay coatings. These coatings are applied using various methods including pack or above-pack aluminizing processes, chemical vapor deposition, electron beam physical vapor deposition, high velocity oxygen fuel deposition, low pressure plasma spray deposition, and cold spray deposition.

Platinum aluminides are established coatings that are effective environmental barriers for turbine components that experience high operating temperature and pressures. Some of the more complex coating procedures such as plating, pack or above-pack cementation, chemical vapor deposition aluminizing, and/or one or more diffusion heat treatments may be necessary to form platinum-modified nickel aluminides. Furthermore, platinum is an expensive metal, and adding platinum to aluminide coatings substantially increases component production costs.

Accordingly, it is desirable to reduce turbine component production costs while also improving the coating performance. In addition, it is desirable to provide relatively inexpensive coating processes and chemistries to produce aluminide coatings that are equally or more effective than conventional platinum-modified aluminide coatings. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

According to an embodiment of the invention, a method is provided for manufacturing a gas turbine engine component. First, a substrate having an outer surface is formed. The substrate includes a nickel-based superalloy that includes at least one reactive element. A first coating comprising aluminum is then formed on the substrate outer surface. The at least one reactive element is then diffused into the first coating to produce a reactive element-modified aluminide coating.

According to another embodiment of the invention, a method for manufacturing a gas turbine engine component begins by forming a substrate having an outer surface. The substrate includes a nickel-based superalloy. The substrate is then coated with a layer that includes at least one reactive element. The at least one reactive element is then diffused into the substrate. A first coating comprising aluminum is formed on the substrate outer surface. Then, the at least one reactive element is diffused into the first coating to produce a reactive element-modified aluminide coating.

### BRIEF DESCRIPTION OF THE DRAWINGS

The present invention will hereinafter be described in conjunction with the following drawing figures, wherein like numerals denote like elements, and

FIG. 1 is a perspective view of a gas turbine blade;

FIG. 2 is a cross-sectional view of a gas turbine engine component according to an embodiment of the present invention;

FIG. 3 is a cross-sectional view of the gas turbine engine component depicted in FIG. 2 coated with an environmental barrier coating according to an embodiment of the present invention;

FIG. 4 is a cross-sectional view of the gas turbine engine component depicted in FIG. 3 after heating the component and the environmental barrier coating according to an embodiment of the present invention;

FIG. 5 is a cross-sectional view of a gas turbine engine component depicted having a reactive element coating formed thereon to be diffused into a superalloy that forms the gas turbine engine component according to an embodiment of the present invention;

FIG. 6 is a perspective view of a gas turbine blade having an environmental barrier coating, and having a lower airfoil portion coated with a chromium-containing coating;

FIG. 7 is a cross-sectional view of a gas turbine engine component having an environmental barrier coating and a chromium-containing coating formed thereon; and

FIG. 8 is a cross-sectional view of the gas turbine engine component depicted in FIG. 7 after diffusing the chromium-containing coating into the environmental barrier coating.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

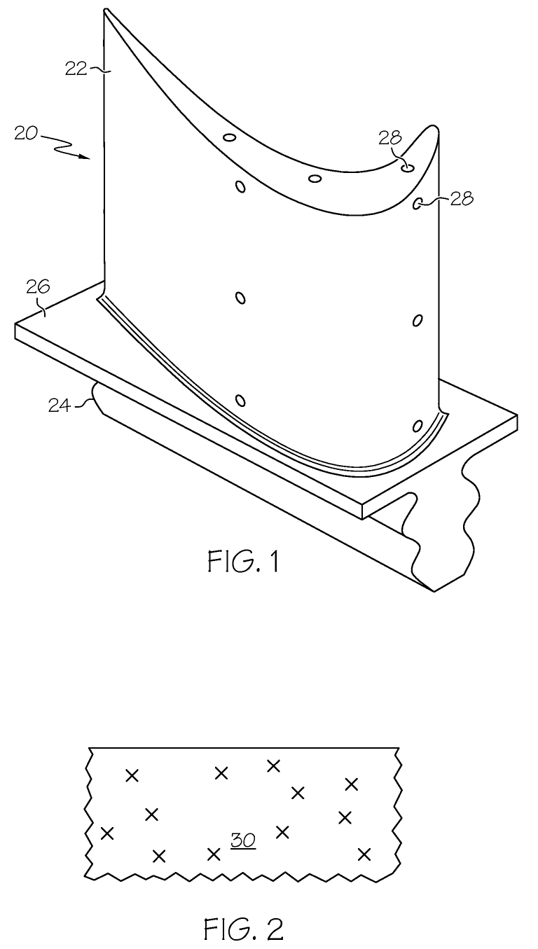

Referring to the drawings, FIG. 1 depicts a turbine blade 20 for a gas turbine engine. The blade 20 may be formed from any operable materials, but typically is a nickel-based superalloy. Among the blade components is an airfoil 22 against which the flow of hot exhaust gas is directed. The blade 20 is mounted to a non-illustrated turbine disc by a dovetail 24 that extends downwardly from the airfoil 22 and engages a slot on the turbine disc. A platform 26 extends longitudinally outwardly from the area where the airfoil 22 is joined to the dovetail 24. Some turbine blades, including the blade 20 depicted in FIG. 1, a number of cooling channels extend through the airfoil interior, ending with openings 28 in the airfoil surface. A flow of cooling air is directed through the cooling channels to reduce the airfoil temperature.

The blade 20 is at least partially coated with an environmental protective coating that is formed according to a method depicted in FIGS. 2 to 4. The blade 20 is just one example of a turbine engine component that may be coated with the environmental barrier coating. Other turbine components and engine substrates may also be protected using an environmental protective coating that is formed according to the methods of the present invention.

Turning now to FIG. 2, a cross section of a turbine engine component substrate 30 is depicted. The substrate 30 is formed from a nickel-based superalloy that includes a high concentration of at least one reactive element such as Hf, Y, Zr, and/or La. The substrate 30 may also include additional elements such as Re, Ta, and/or Si. According to an exemplary embodiment, the superalloy includes reactive element Hf at a concentration ranging between 0.2 and 1.5 wt. %. A preferred Hf concentration in the superalloy ranges between 0.9 and 1.3 wt. %. As will be described, the Hf and/or other reactive elements will be partially diffused out of the superalloy substrate 30 and into an overlying aluminide coating. Research by the present inventors reveals that Hf-modified aluminide coatings perform better as environmental protective coatings than platinum-modified environmental barrier coatings. It is therefore advantageous to have a relatively high Hf and/or other reactive element concentration in the superalloy substrate 30 to enable diffusion out of the superalloy and into the overlying aluminide coating. To further improve the coating process, the superalloy substrate 30 preferably also includes at least 100 ppm of Y and/or La. Furthermore, the coating process is optimized when the superalloy substrate 30 does not include Ti. The one or more reactive elements in protective coatings function as sulfur getters. When turbine hardware is exposed to high temperatures, the reactive elements react with sulfur to form stable sulfides. In this way, sulfur cannot diffuse to the free surface and then destroy a thin alumina protective scale formed thereon. In addition, the addition of titanium in superalloys negatively affects the coating performance due to its active reaction with oxygen to form non-protective titanium oxide.

As depicted in FIG. 2, the at least one reactive element concentration is represented by “x.” As previously discussed, the at least one reactive element may be alloyed with other metals as a component of the superalloy. An exemplary superalloy for the turbine engine component substrate 30 is outlined in terms of its chemical composition in Table 1.

TABLE 1

| | [wt. %] | | More Preferred |
|---|---|---|---|
| Element | Range | Preferred [wt. %] Range | [wt. %] |
| C | 0.05–0.12 | 0.08–0.12 | 0.10 |
| Al | 6.00–6.40 | 6.00–6.40 | 6.20 |
| Ta | 5.80–6.30 | 5.80–6.30 | 6.00 |
| Al + Ta | | ≧12.00 | 12.20 |
| Cr | 5.00–7.50 | 6.20–6.80 | 6.50 |
| Co | 8.00–9.80 | 9.30–9.80 | 9.60 |
| Mo | 1.00–1.70 | 1.30–1.70 | 1.50 |
| Re | 2.00–5.00 | 2.80–3.20 | 3.00 |
| W | 3.80–5.00 | 3.80–4.30 | 4.00 |
| Mo + W + Re | | ≧8.00 | 8.50 |
| Ru | 2.00–5.00 | 2.40–2.80 | 2.60 |
| Hf | 0.20–1.50 | 0.90–1.30 | 1.10 |
| B | 0.004–0.014 | 0.008–0.014 | 0.01 |
| Zr | 0.008–0.03 | 0.01–0.03 | 0.02 |
| Si | ≦0.10 | ≦0.10 | ≦0.10 |
| Y | 0.003–0.015 | 0.008–0.015 | 0.01 |
| Ni | balance | balance | balance |

According to one exemplary embodiment, the superalloy is formed while casting the engine component substrate 30 into a preliminary or a final form. The casting process includes the step of placing elemental metallic ingots or nuggets into a vacuum induction melting furnace. The at least one reactive element is also included among the elemental metals. The metallic ingots or nuggets are then melted and reacted to form the nickel-based superalloy by heating the metallic materials in the vacuum induction melting furnace.

According to another embodiment, all or supplementary amounts of the at least one reactive element is diffused into the coating. For example, when hafnium is selected as a reactive element, then hafnium will be add to the superalloy. During the aluminizing process, hafnium diffuses into the aluminide coating from the base superalloy to form a hafnium-modified aluminide coating. In terms of metallurgical principle, beta phase aluminide only has low solubility of Hf (0.2 wt. % Hf). This low percentage of Hf in the aluminide coating greatly improves the coating's oxidation performance. Turning briefly to FIG. 5, a hafnium layer 34 is deposited onto the substrate 30. The hafnium (represented by “x”) is then thermally diffused into the substrate 30. The hafnium concentration in the superalloy substrate 30 after diffusion is determined primarily by the hafnium layer thickness or weight percentage. As previously discussed, it is advantageous to have a sufficiently high Hf and/or other reactive element concentration diffused into the superalloy substrate 30 to enable diffusion out of the superalloy substrate 30 and into the overlying aluminide coating that is to be subsequently formed.

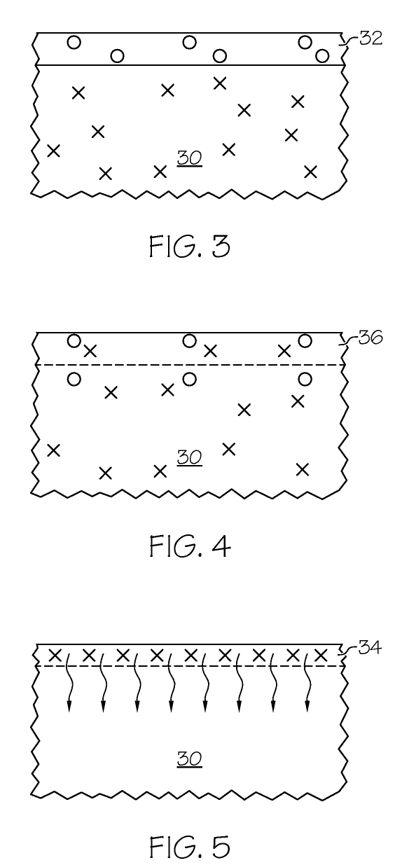

Turning now to FIG. 3, after providing a superalloy having reactive elements alloyed and supplemented therein, an aluminizing step is performed on the superalloy substrate 30. A coating layer 32 that includes aluminum (represented by “o”) is deposited onto the superalloy substrate 30. The coating layer 32 is deposited to a predetermined thickness that will, in part, determine the total aluminum content in the environmental protective coating following a subsequent thermal diffusion process.

After forming the coating layer 32, the substrate and coating are heated to a temperature that is sufficient for the at least one reactive element to partially diffuse out of the superalloy substrate 30 and into the coating layer 32. As depicted in FIG. 4, the aluminum (represented by “x”) in the coating layer 32 may partially diffuse into the superalloy substrate 30, while reactive element hafnium and/or other reactive elements (represented by “x”) partially diffuse into the coating layer 32. In addition, nickel and other alloy elements are co-diffused into the coating layer 32 during the aluminizing process and post diffusion heat treatment. The heat treatment produces an environmental protective coating 36 that includes one or more reactive elements.

The heating period and temperature are predetermined and tailored to produce the environmental protective coating 36 that has a desirable thickness and chemical composition. According to an exemplary embodiment, the heat treatment is performed at a temperature ranging between 1900 and 2000° F. for a period of 2 to 8 hours to homogenize the environmental protective coating chemistry and microstructure. An exemplary environmental protective coating 36 produced according to the present methods includes, in terms of weight, 12 to 25% Al, 0.15 to 0.8% Hf, 0.1 to 1.0% Si, with the remainder being Ni. Furthermore, it is preferable that the environmental protective coating does not include Pt. As previously discussed, platinum aluminides are established coatings that are effective environmental barriers for high temperature and pressure turbine components. However, some of the more complex coating procedures may be necessary to form platinum-modified nickel aluminides. Furthermore, platinum is an expensive precious metal, and adding platinum to aluminide coatings substantially increases component production costs. The present inventors have discovered that other reactive element-modified aluminide coatings, and particularly hafnium-modified aluminide coatings, perform as well as or better than platinum-modified coatings at operating conditions for turbine engine hot section components.

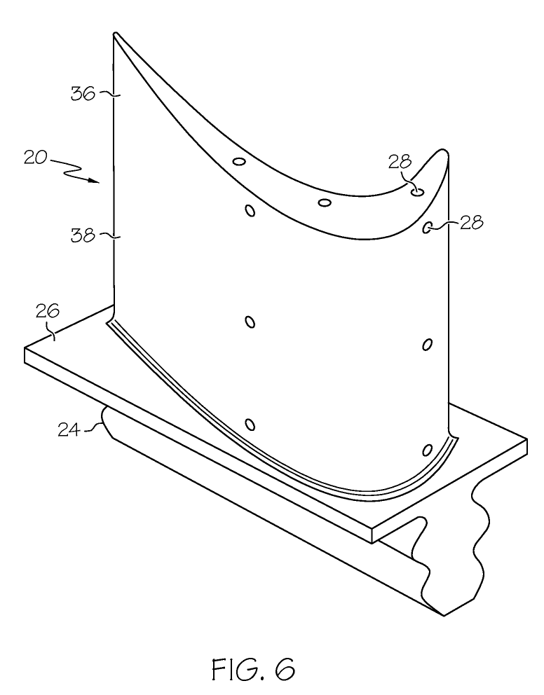

Turning now to FIG. 6, a perspective view of a turbine engine blade is depicted. The blade 20 has a dual-coating structure, which includes an upper portion having the effective oxidation protective coating 36, and a lower portion having a corrosion barrier coating 38.

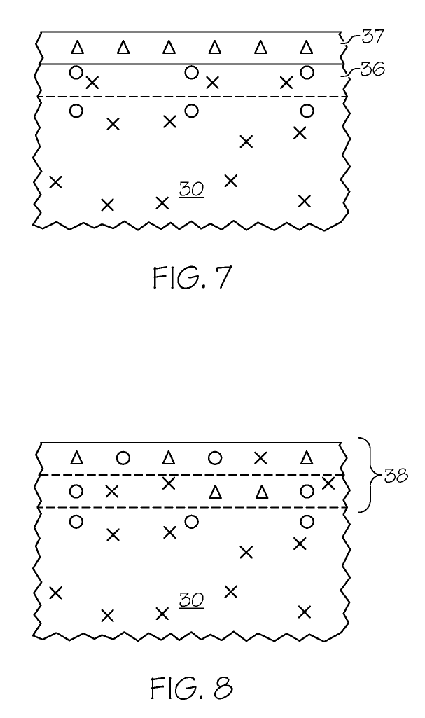

FIG. 7 is a cross-sectional view of the turbine engine component as depicted in FIG. 4 having the environmental barrier coating 36 formed therein. An oxidation protective coating is formed by first making the environment-resistant coating 36 with a coating 37 that includes chromium (represented by “A”). In a preferred embodiment, a dual coating structure is formed by preventing diffusion of the chromium from a Cr-modified coating to the oxidation protective coating. For example, a turbine blade may benefit by coating the upper portion with only the oxidation protective coating 36 discussed previously. However, a lower portion may best benefit from an additional chromium treatment to prevent corrosion attack of the turbine blade. In such a case, the upper blade region may be masked or otherwise inhibited from receiving the chromium-doped coating 37.

After forming the chromium-doped coating 37, the component is heated at a temperature and for a duration sufficient to diffuse the chromium at least into the underlying environmental barrier coating 36. Furthermore, some reactive elements from the environmental barrier coating may diffuse into the chromium-doped coating 37 to form a reactive element-modified nickel aluminum chromide coating 38.

The coating methods of the present invention are therefore effective for forming single or multiple coating systems for gas turbine engine components that provide environment and/or oxidation protection for the component surfaces, thereby improving the component reliability and service lives. Furthermore, the coating costs are dramatically reduced by incorporating hafnium or other reactive elements into the turbine hot section component coatings instead of platinum-modified aluminides.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for manufacturing a gas turbine engine component, comprising the steps of:
forming a substrate having an outer surface, the substrate comprising a nickel-based superalloy that includes at least one reactive element;
forming a first coating comprising aluminum on the substrate outer surface; and
diffusing the at least one reactive element into the first coating to produce a reactive element-modified aluminide coating.

2. The method according to claim 1, wherein the step of forming the substrate produces the nickel-based superalloy, which comprises by weight 0.05-0.12% C, 6.0-6.4% Al, 5.8-6.3% Ta, 5.0-7.5% Cr, 8.0-9.8% Co, 1.0-1.7% Mo, 2.0-5.0% Re, 2.8-5.0% W, 2.0-5.0% Ru, 0.2-1.5% Hf, 0.004-0.024% B, 0.008-0.03% Zr, 0.003-0.015% Y, up to 0.10% Si, and Ni.

3. The method according to claim 1, wherein the step of forming the substrate produces the nickel-based superalloy having the at least one reactive element, which comprises at least one element selected from the group consisting of Hf, Zr, Y, and La.

4. The method according to claim 3, wherein the step of forming the substrate produces the nickel-based superalloy that further includes at least one element selected from the group consisting of Re, Ta, and Si.

5. The method according to claim 1, wherein the step of diffusing the at least one reactive element into the coating produces the reactive element-modified aluminide, which comprises by weight 12-25% Al, 0.15-0.8% Hf, 0.1-1.0% Si, and Ni.

6. The method according to claim 1, wherein the step of diffusing the at least one reactive element into the coating produces the reactive element-modified aluminide, which has an absence of Pt.

7. The method according to claim 1, wherein the step of forming the substrate produces the nickel-based superalloy, which comprises at least 100 ppm of a reactive element selected from the group consisting of Y, Hf, and La.

8. The method according to claim 1, wherein the step of diffusing the at least one reactive element into the coating comprises heating the substrate at a temperature ranging between 1900 and 2000° F. for a duration ranging between 2 and 8 hours.

9. The method according to claim 1, further comprising the steps of:
forming a second coating comprising chromium on at least a portion of the reactive element-modified aluminide coating; and
diffusing the chromium into the reactive element-modified aluminide coating.

10. The method according to claim 9, further comprising the step of:
preventing formation of the second coating on a region of the reactive element-modified aluminide coating.

11. A method for manufacturing a gas turbine engine component, comprising the steps of:
forming a substrate having an outer surface, the substrate comprising a nickel-based superalloy;
coating the substrate with a reactive element layer comprising at least one reactive element;
diffusing the at least one reactive element into the substrate;
forming a first coating comprising aluminum on the substrate outer surface; and
diffusing the at least one reactive element into the first coating to produce a reactive element-modified aluminide coating.

12. The method according to claim 11, wherein the step of forming the substrate produces the nickel-based superalloy having the at least one reactive element, which comprises at least one element selected from the group consisting of Hf, Zr, Y and La.

13. The method according to claim 12, wherein the step of forming the substrate produces the nickel-based superalloy that further includes at least one element selected from the group consisting of Re, Ta, and Si.

14. The method according to claim 11, wherein the step of diffusing the at least one reactive element into the coating produces the reactive element-modified aluminide, which comprises by weight 12-25% Al, 0.15-0.8% Hf, 0.1-1.0% Si, and Ni.

15. The method according to claim 11, wherein the step of diffusing the at least one reactive element into the coating produces the reactive element-modified aluminide, which has an absence of Pt.

16. The method according to claim 11, wherein the step of forming the substrate produces the nickel-based superalloy, which comprises at least 100 ppm of a reactive element selected from the group consisting of Y and La.

17. The method according to claim 11, wherein the step of diffusing the at least one reactive element into the coating comprises heating the substrate at a temperature ranging between 1900 and 2000° F. for a duration ranging between 2 and 8 hours.

18. The method according to claim 11, further comprising the steps of:
forming a second coating comprising chromium on at least a portion of the reactive element-modified aluminide coating; and
diffusing the chromium into the reactive element-modified aluminide coating.

19. The method according to claim 18, further comprising the step of:
preventing formation of the second coating on a region of the reactive element-modified aluminide coating.
